(19) United States
(12) Patent Application Publication
(10) Pub. No.: US 2025/0046938 A1
(43) Pub. Date: Feb. 6, 2025

(54) POWER ASSEMBLY AND HOUSEHOLD APPLIANCE

(71) Applicant: TOGROUP TECHNOLOGY (SUZHOU) CO., LTD, SUZHOU (CN)

(72) Inventors: HAI BO WANG, SUZHOU (CN); PENG WU, SUZHOU (CN)

(21) Appl. No.: 18/407,452

(22) Filed: Jan. 9, 2024

(30) Foreign Application Priority Data
Aug. 1, 2023 (CN) 2023220392240
Sep. 28, 2023 (CN) 2023226619544

(51) Int. Cl. H01M 50/262; A47J 43/046; A47J 43/08; B25F 5/00; H01M 50/202; H01M 50/247; H02K 7/14; H02K 11/00

(52) U.S. Cl. CPC H01M 50/262; A47J 43/046; A47J 43/085; H01M 50/202; H01M 50/247; H02K 7/14; H02K 11/0094; B25F 5/00; H01M 2220/30

(57) ABSTRACT

A power assembly for a power tool and a household appliance, the power tool includes a tool body and a tool interface, the household appliance includes a base and an appliance interface, the power assemble includes a battery pack and a connecting component removably connected to the battery pack. The battery pack includes a power supply interface. The connecting component includes a first locking portion for locking with the base and a first driving portion for driving the first locking portion to unlock from the base. The battery pack is configured to be removably assembled with the tool body, so that an electrical connection between the tool interface and the power supply interface is formed or eliminated. The connecting component is configured to be removably assembled with the base, so that an electrical connection between the appliance interface and the power supply interface is formed or eliminated.

### FIELD OF THE INVENTION

The invention pertains to the field of batteries, especially to a power assembly and a small household appliance.

### BACKGROUND OF THE INVENTION

In the field of power tools, tools powered by lithium batteries are becoming increasingly popular. Lithium batteries have advantages such as high energy density, lightweight, and long lifespan. More importantly, the power supply interfaces of the lithium batteries for the tools are standardized (i.e., platformization of battery pack), so that a battery pack can power dozens, or even hundreds of tools, for example, the tool can be electric screwdrivers, drills, hammers, angle grinders, sanders, jigsaws, reciprocating saws, circular saws, chainsaws, pruners, and so on.

On the other hand, in the field of household appliances, especially small household appliances, most small household appliances are powered by AC power. The power cables can interfere with operation of user, and the use of AC power is not very safe. In response to this, appliances powered by built-in lithium batteries have appeared on the market. However, each machine needs to be equipped with a lithium battery, inevitably leading to an increase in cost.

### SUMMARY OF THE INVENTION

This application provides a power assembly that can be applied to a plurality of power tools and a plurality of household appliances, as well as a household appliance.

The invention provides a power assembly for a power tool and a household appliance, the power tool includes a tool body and a tool interface formed on the tool body, the household appliance includes a base and an appliance interface formed on the base, the power assembly includes a battery pack and a connecting component removably connected to the battery pack, the battery pack includes a shell and at least one battery cell arranged in the shell, the battery pack includes a power supply interface electrically connected with the at least one battery cell, the connecting component includes a first locking portion for locking with the base and a first driving portion for driving the first locking portion to unlock from the base; wherein the battery pack is configured to be removably assembled with the tool body, so that an electrical connection between the tool interface and the power supply interface is formed or eliminated; and the connecting component is configured to be removably assembled with the base, so that an electrical connection between the appliance interface and the power supply interface is formed or eliminated.

This invention also provides a household appliance, the household appliance includes the power assembly described above, the household appliance includes a base and an appliance interface formed on the base, the base includes a docking cavity, the appliance interface is disposed in the docking cavity, the appliance interface is electrically connected with the power supply interface of the power assembly in the docking cavity, the household appliance includes a motor and an output shaft driven by the motor, the motor is received in the base and electrically connected with the appliance interface, wherein the power assembly is configured to be removably assembled with the base, so that an electrical connection between the appliance interface and the power supply interface is formed or eliminated; the base also includes a position limiting slot communicating with the docking cavity, and the first locking portion cooperates with the position limiting slot to lock the first locking portion with the base; the battery pack of the power assembly is a battery pack for a power tool, the power tool includes a tool body and a tool interface formed on the tool body, and the battery pack can be removably assembled with the tool body, so that an electrical connection between the tool interface and the power supply interface is formed or eliminated.

The battery pack of the power assembly of this application can adapt to a plurality of power tools. The power assembly as a whole can adapt to a plurality of household appliances, further enhancing universality of the battery pack, which is beneficial for cost reduction.

### BRIEF DESCRIPTION OF THE DRAWINGS

FIG. 1 is a perspective view of one embodiment of the power assembly of the present application;

FIG. 2 is a perspective view of the power assembly shown in FIG. 1 from another angle;

FIG. 3 is an exploded perspective view of the power assembly shown in FIG. 2;

FIG. 4 is another exploded perspective view of the power assembly shown in FIG. 2;

FIG. 5 is an exploded perspective view of the power assembly shown in FIG. 4 from another angle;

FIG. 6 is an exploded perspective view of the connecting component shown in FIG. 5;

FIG. 7 is a perspective view of a partial structure of the connecting component shown in FIG. 6;

FIG. 8 is a further exploded perspective view of the connecting component shown in FIG. 6;

FIG. 9 is a perspective view of the base of a household appliance of the present application assembled with the power assembly shown in FIG. 1;

FIG. 10 is an exploded perspective view of the structure shown in FIG. 9;

FIG. 11 is a cross-sectional view of the structure shown in FIG. 10;

FIG. 12 is a perspective view of another embodiment of the power assembly of the present application;

FIG. 13 is an exploded perspective view of the power assembly shown in FIG. 12;

FIG. 14 is a perspective view of the base of a household appliance of the present application assembled with the power assembly shown in FIG. 12;

FIG. 15 is a perspective view of the base shown in FIG. 14;

FIG. 16 is an enlarged view of a partial structure of FIG. 15;

FIG. 17 is a perspective view of an assembled structure of a battery pack and a power tool of the present application;

FIG. 18 is an exploded perspective view of the battery pack and the power tool shown in FIG. 17.

### DETAILED DESCRIPTION OF THE EMBODIMENTS

Herein, exemplary embodiments will be described in detail with reference to the accompanying drawings. When referring to the drawings, unless otherwise specified, the same numbers in different drawings refer to the same or similar elements. The embodiments described in the following exemplary embodiments do not represent all embodiments consistent with the present application.

Terms used in the present application are merely for the purpose of describing specific embodiments and are not intended to limit the application. Unless otherwise defined, technical or scientific terms used in the present application should be understood in their common sense by persons having ordinary skill in the art to which the invention belongs. The terms “first”, “second”, and the like in this application do not denote any order, quantity, or importance but are used to distinguish different components. Similarly, words like “a” or “an” do not denote quantity but indicate the presence of at least one. “Several” or “multiple” indicates two or more. Unless otherwise indicated, terms such as “front”, “rear”, “bottom”, and/or “top” are used for convenience in description and are not limited to a specific position or spatial orientation. Words like “comprising” or “including” denote inclusion of elements or objects listed before them, and their equivalents, without excluding other elements or objects. Words like “connected” or “linked” are not limited to physical or mechanical connections and can comprise electrical connections, whether direct or indirect. Singular forms “a”, “the”, and “said” also comprise plural forms unless the context clearly indicates otherwise. It should also be understood that the term “and/or” as used herein refers to and encompasses any and all possible combinations of one or more of the associated listed items.

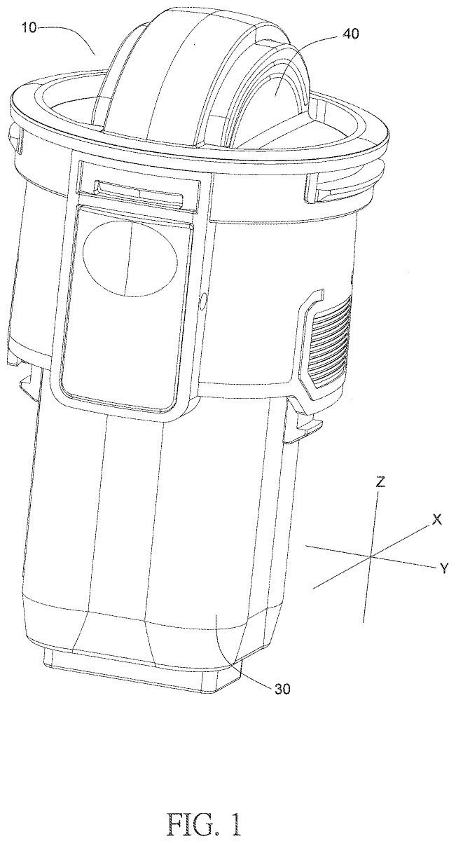

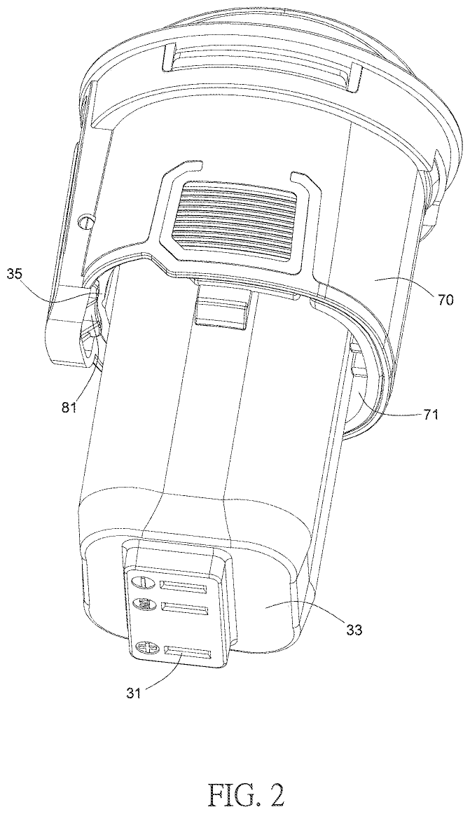

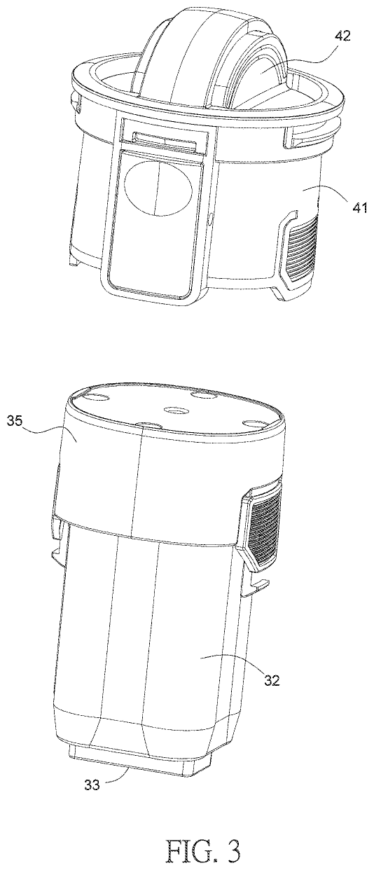

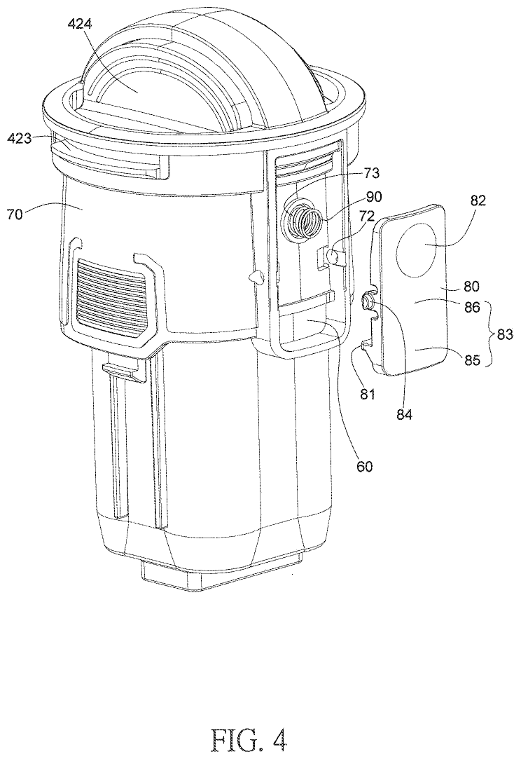

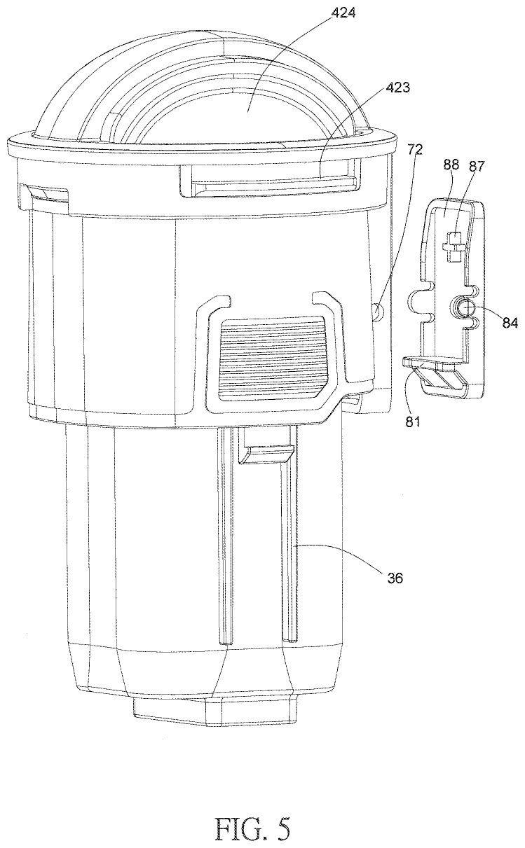

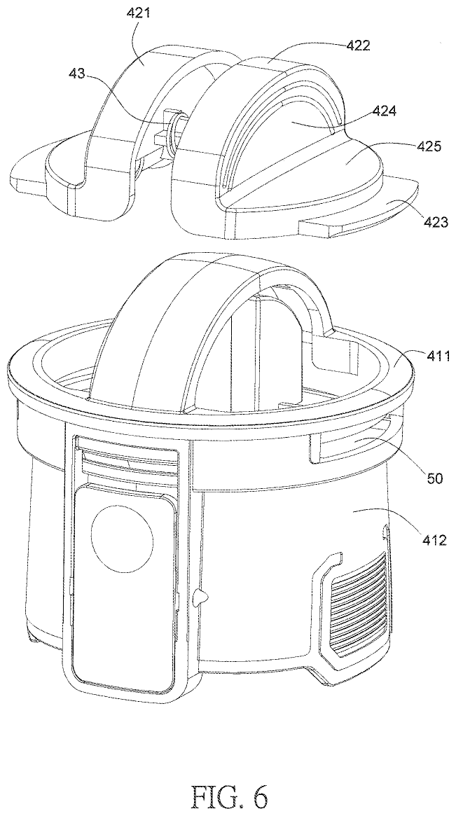

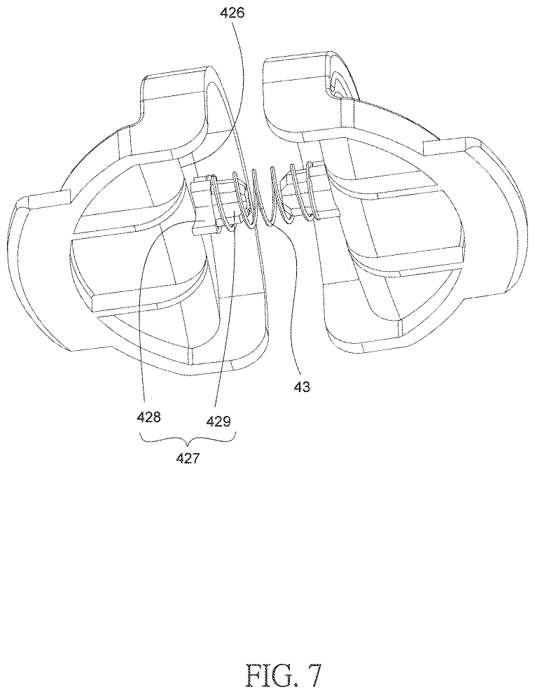

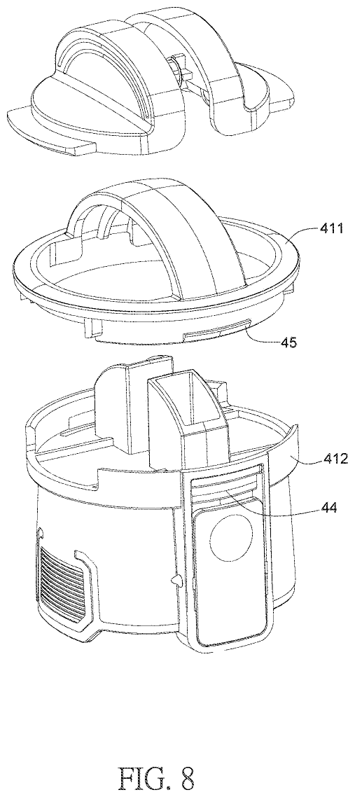

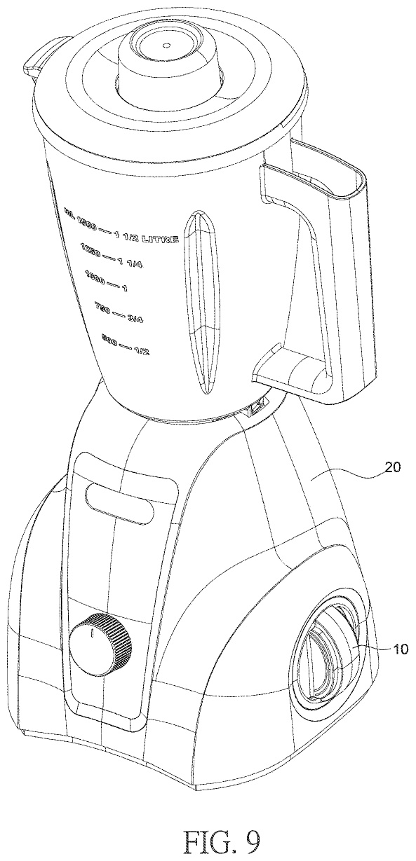

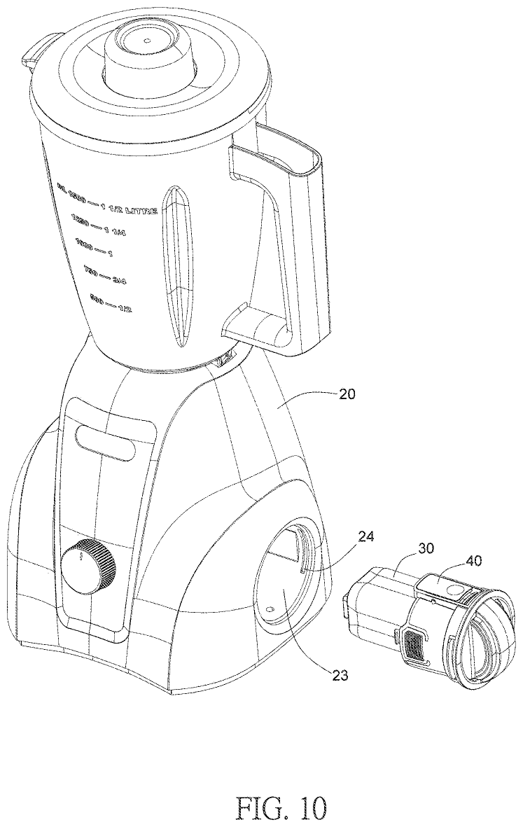

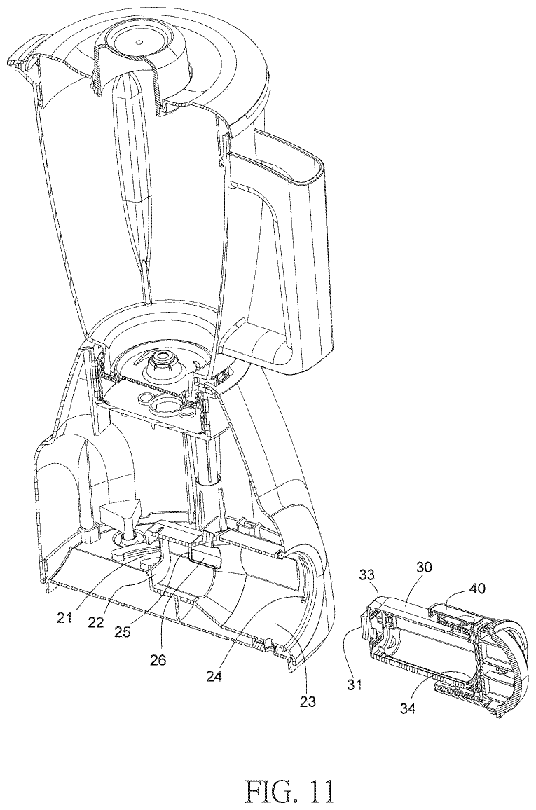

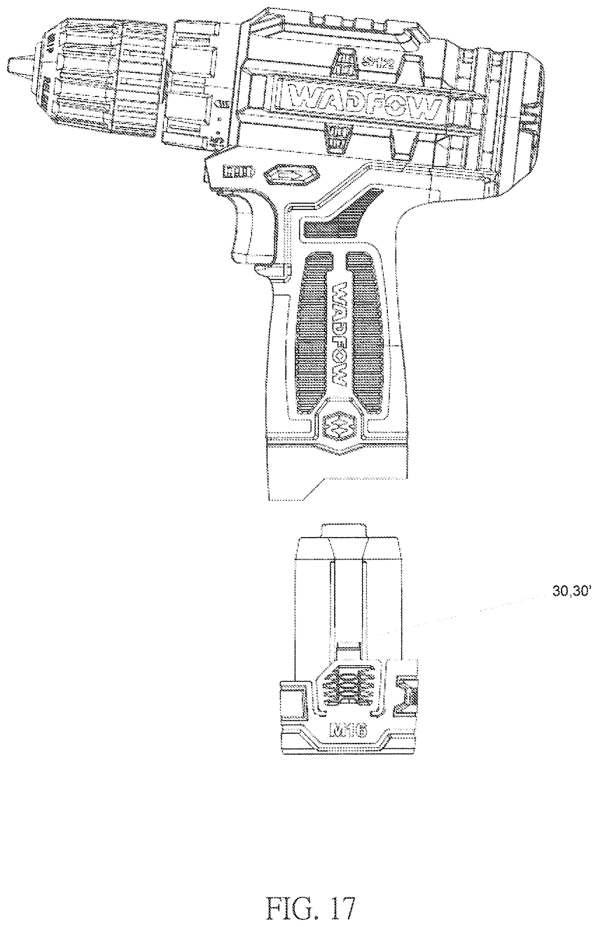

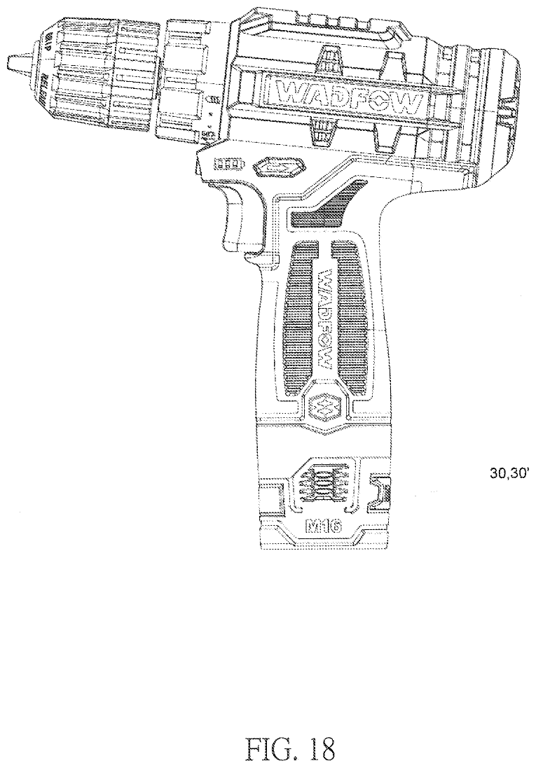

Referring to FIGS. 1 to 11, FIG. 17 and FIG. 18, a first embodiment of the present application provides a power assembly 10, which is used for a plurality of power tools and a plurality of household appliances 20. The power tool includes a tool body and a tool interface formed on the tool body, the household appliance 20 includes a base 22 and an appliance interface 21 formed on the base 22. The power assembly 10 includes a battery pack 30 and a connecting component 40 that is removably connected to the battery pack 30. Referring to FIG. 17 and FIG. 18, the battery pack 30 is for a plurality of power tools and includes a power supply interface 31, the battery pack 30 is configured to be removably assembled with the tool body, so that an electrical connection between the tool interface and the power supply interface 31 is formed or eliminated. The connecting component 40 is configured to be removably assembled with the base 22, so that an electrical connection between the appliance interface 21 and the power supply interface 31 is formed or eliminated. The plurality of power tools can include electric drill, electric hammer, angle grinder, sander, curve saw, reciprocating saw, electric circular saw, chain saw, pruner and so on, in this embodiment, the power tool is an electric drill. The plurality of household appliances can include juicer, flour mixer, meat grinder, multifunctional food processor, vacuum cleaner and so on, in this embodiment, the household appliance is a multifunctional food processor.

The battery pack 30 includes a shell 32 and at least one battery cell (not shown) received in the shell 32. The battery cell is electrically connected to the power supply interface 31. The battery pack 30 extends in a first direction Z and has a first end 33 and a second end 34 arranged along the first direction Z, the power supply interface 31 is disposed at the first end 33. The battery pack 30 also includes a holder 35, which is disposed at the second end 34.

The connecting component 40 includes a bracket 41, two locking members 42 mounted on the bracket 41, and a first elastic member 43 positioned between the two locking members 42. The two locking members 42 are corresponding to each other and arranged along a second direction Y. The bracket 41 includes a first bracket 411 and a second bracket 412 that are arranged along the first direction Z and assembled with each other. Two first through slots 50 are formed after the first bracket 411 and the second bracket 412 are assembled with each other, the two first through slots 50 are corresponding to each other and arranged in the second direction Y, the first through slot 50 penetrates in the second direction Y, the second direction Y is perpendicular to the first direction Z. The second bracket 412 includes two holding slots 44 corresponding to each other and arranged along a third direction X. The holding slot 44 penetrates in the third direction X. The first bracket 411 includes two holding portions 45, the holding portion 45 extends in the third direction X. The two holding portions 45 are respectively held in the two holding slots 44, enabling the first bracket 411 and the second bracket 412 to be assembled with each other. The third direction X is perpendicular to the first direction Z, and the third direction X is perpendicular to the second direction Y.

The two locking members 42 are mounted on the first bracket 411. The locking member 42 includes a first locking portion 423 and a first driving portion 424 that drives the first locking portion 423 to move. The first driving portion 424 is exposed to the first bracket 411 for operation of user. In this embodiment, the locking member 42 also includes a first base portion 425 located between the first locking portion 423 and the first driving portion 424. The first locking portion 423, the first driving portion 424 and the first base portion 425 are integrally formed. The first locking portion 423 extends in the second direction Y, the first driving portion 424 extends in the first direction Z, and the first locking portion 423 is perpendicular to the first driving portion 424.

The two locking members 42 include a first locking member 421 and a second locking member 422. The first locking portion 423 of the first locking member 421 passes through one of the two first through slots 50 and is exposed to the bracket 41. The first locking portion 423 of the second locking member 422 passes through the other one of the two first through slots 50 and is exposed to the bracket 41. The first locking portion 423 is used to lock with the base 22 of the household appliance 20 to fix the power assembly 10 to the base 22.

The first elastic member 43 is configured to provide a restoring force for the first locking portion 423. One end of the first elastic member 43 cooperates with the first driving portion 424 of the first locking member 421, and the other end of the first elastic member 43 cooperates with the first driving portion 424 of the second locking member 422. The first driving portion 424 of the first locking member 421 and the first driving portion 424 of the second locking member 422 are corresponding to each other and arranged along the second direction Y, which is perpendicular to the first direction Z, and a first driving direction of the first driving portion 424 of the first locking member 421 is opposite to a second driving direction of the first driving portion 424 of the second locking member 422, and the first driving direction and the second driving direction are parallel to the second direction Y. The first driving portion 424 includes a first actuating portion 426 and a first positioning element 427 extending from the first actuating portion 426. Two ends of the first elastic member 43 are respectively cooperated with the first positioning element 427 of the first driving portion 424 of the first locking member 421 and the first positioning element 427 of the first driving portion 424 of the second locking member 422. In this embodiment, the first elastic member 43 is a spring. The first positioning element 427 is a positioning protrusion, which includes a body portion 428 extending from the first actuating portion 426 and a positioning column 429 extending from the body portion 428. The radial size of the body portion 428 is larger than the radial size of the positioning column 429. The two ends of the spring 43 are respectively sleeved on the positioning column 429 of the first positioning element 427 of the first driving portion 424 of the first locking member 421 and the positioning column 429 of the first positioning element 427 of the first driving portion 424 of the second locking member 422, and the two ends of the spring 43 respectively press against the body portion 428 of the first positioning element 427 of the first driving portion 424 of the first locking member 421 and the body portion 428 of the first positioning element 427 of the first driving portion 424 of the second locking member 422. The radial direction of the body portion 428 is perpendicular to the extending direction of the body portion 428, and the radial direction of the positioning column 429 is perpendicular to the extending direction of the positioning column 429.

When it is necessary to unlock the power assembly 10 from the base 22 of the household appliance 20, the user presses the first actuating portion 426 of the first driving portion 424 of the first locking member 421 along the first driving direction and the first actuating portion 426 of the first driving portion 424 of the second locking member 422 along the second driving direction respectively. The first driving portion 424 of the first locking member 421 drives the first locking portion 423 of the first locking member 421 to move, the first driving portion 424 of the second locking member 422 drives the first locking portion 423 of the second locking member 422 to move, so that the first locking portion 423 of the first locking member 421 and the first locking portion 423 of the second locking member 422 are separated from the base 22. When the user releases the first driving portion 424 of the first locking member 421 and the first driving portion 424 of the second locking member 422 respectively, under an action of the first elastic member 43, the first driving portion 424 of the first locking member 421 and the first driving portion 424 of the second locking member 422 return to their initial positions. Simultaneously, the first driving portion 424 of the first locking member 421 drives the first locking portion 423 of the first locking member 421 back to its initial position, the first driving portion 424 of the second locking member 422 drives the first locking portion 423 of the second locking member 422 back to its initial position.

The second bracket 412 includes a main body 70, a movable member 80 movably connected to the main body 70, and a second elastic member 90 located between the main body 70 and the movable member 80. The main body 70 has a mounting cavity 71 with a mounting opening. The second end 34 of the battery pack 30 is inserted into the mounting cavity 71 through the mounting opening, the holder 35 is located in the mounting cavity 71. The first end 33 of the battery pack 30 is located outside the mounting cavity 71.

The movable member 80 includes a second locking portion 81 and a second driving portion 82 for driving the second locking portion 81 to move. The second locking portion 81 locks with the battery pack 30 to fix the battery pack 30 to the connecting component 40. Specifically, the main body 70 has a second through slot 60 penetrating in the third direction X, the second through slot 60 is communicated with the mounting cavity 71. The second locking portion 81 enters the mounting cavity 71 through the second through slot 60 to lock with the holder 35. In this embodiment, the movable member 80 also includes a second base portion 83 located between the second locking portion 81 and the second driving portion 82. The second locking portion 81, the second driving portion 82, and the second base portion 83 are integrally formed. The second locking portion 81 extends along the third direction X, the second driving portion 82 extends along the first direction Z, and the second locking portion 81 is perpendicular to the second driving portion 82.

The main body 70 has a positioning hole 72. The movable member 80 includes a positioning pin 84 which is inserted into the positioning hole 72. The movable member 80 rotates relative to the main body 70 to make the second locking portion 81 lock or unlock with the battery pack 30. The second elastic member 90 is positioned between the second driving portion 82 and the main body 70, the second elastic member 90 is configured to provide a restoring force for the second locking portion 81.

The second base portion 83 includes a first sub-portion 85 and a second sub-portion 86, which are adjacently arranged along the first direction Z. The second locking portion 81 extends from the first sub-portion 85 in the third direction X, and the second driving portion 82 extends from the second sub-portion 86 in the first direction Z. The movable member 80 includes two aforementioned positioning pins 84, the two positioning pins 84 are arranged on both sides of the second sub-portion 86 along the second direction Y, the two positioning pins 84 are aligned along the second direction Y. The main body 70 has two aforementioned positioning holes 72, and the two positioning pins 84 are respectively inserted into the two positioning holes 72 along the second direction Y.

The second driving portion 82 has a second positioning element 87. The main body 70 has a third positioning element 73. One end of the second elastic member 90 is located at the second positioning element 87 of the second driving portion 82, and the other end of the second elastic member 90 is located at the third positioning element 73 of the main body 70. Specifically, the second driving portion 82 includes a second actuating portion 88 and the second positioning element 87 extending from the second actuating portion 88, the second positioning element 87 is a positioning protrusion. The third positioning element 73 is a positioning groove on the main body 70. The second elastic member 90 is a spring, one end of the spring 90 is sleeved on the positioning protrusion 87 of the second driving portion 82 and presses against the second actuating portion 88 of the second driving portion 82. The other end of the spring 90 is received in the positioning groove 73 of the main body 70.

This application also provides a household appliance 20, the household appliance 20 includes a base 22, a motor (not shown) received in the base 22, and an output shaft (not shown) driven by the motor. The household appliance 20 also includes an appliance interface 21 formed on the base 22, the appliance interface 21 is electrically connected to the motor. The aforementioned power assembly 10 can be removably assembled with the base 22, so that an electrical connection between the appliance interface 21 and the power supply interface 31 is formed or eliminated. The base 22 includes a docking cavity 23, the appliance interface 21 is located in the docking cavity 23. An end, which has the power supply interface 31, of the battery pack 30 of the power assembly 10 is inserted into the docking cavity 23 through the docking opening, an electrical connection between the appliance interface 21 and the power supply interface 31 is formed in the docking cavity 23. The docking cavity 23 includes a guiding groove 26 recessed from the inner wall of the docking cavity 23 and a stopping wall 25 located at an end, away from the docking opening, of the guiding groove 26. The battery pack 30 includes a guiding rib 36. When an end, which has the power supply interface 31, of the battery pack 30 of the power assembly 10 is inserted into the docking cavity 23 through the docking opening, the guiding rib 36 cooperates with the guiding groove 26. Under the guidance of the guiding groove 26, an end, near the power supply interface 31, of the guiding rib 36 cooperates with the stopping wall 25, preventing the power assembly 10 from continuing to move towards the appliance interface 21. The base 22 also includes two position limiting slots 24 communicated with the docking cavity 23. When it is necessary to lock the power assembly 10 to the base 22 of the household appliance 20, the power assembly 10 is inserted into the docking cavity 23, and the first locking portion 423 of the first locking member 421 and the first locking portion 423 of the second locking member 422 respectively cooperate with the two position limiting slots 24, so that the first locking portion 423 of the first locking member 421 and the first locking portion 423 of the second locking member 422 are locked with the base 22. When it is necessary to unlock the power assembly 10 from the base 22 of the household appliance 20, user respectively presses the two first actuating portions 426 of the two first driving portions 424 of the connecting component 40 of the power assembly 10, the two first driving portions 424 respectively drive the two first locking portions 423 to move, so that the two first locking portions 423 are separated from the two position limiting slots 24 respectively.

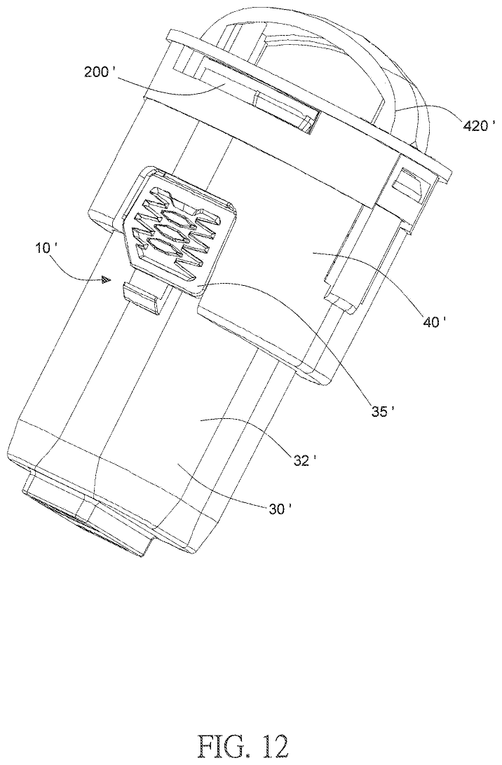

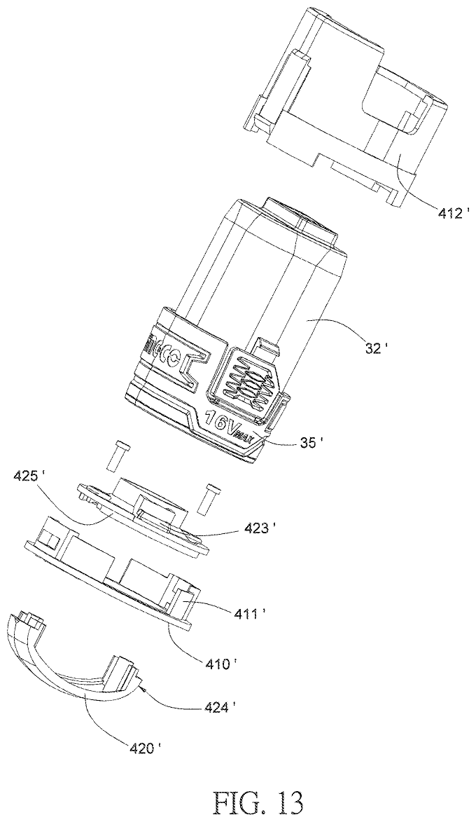

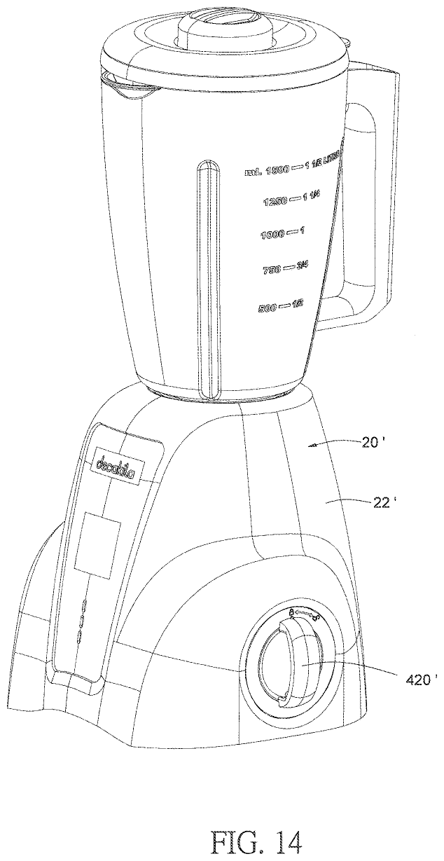

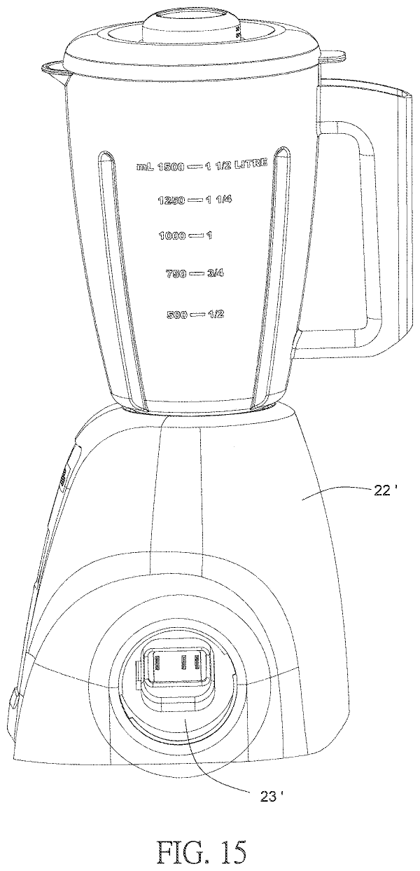

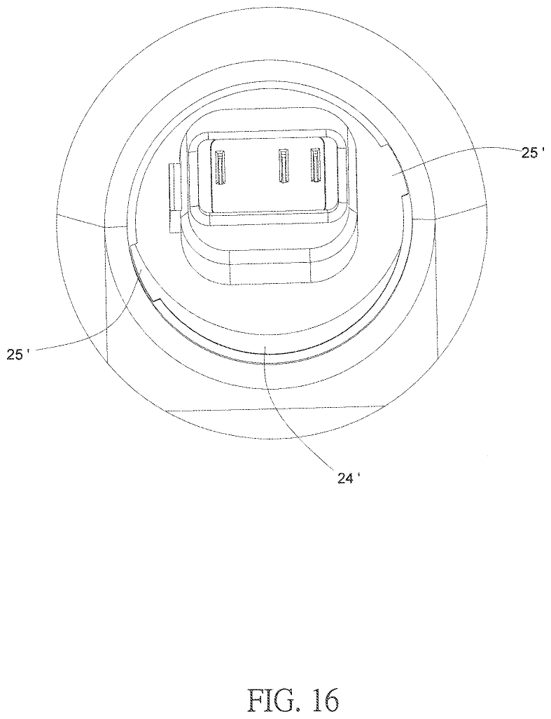

Referring to FIGS. 12 to 16, FIG. 17 and FIG. 18, a second embodiment of the present application provides a power assembly 10′, which is used for a plurality of power tools and a plurality of household appliances 20′. The power assembly 10′ includes a battery pack 30′ and a connecting component 40′ removably connected to the battery pack 30′. The battery pack 30′ includes a shell 32′, a holder 35′, a battery cell (not shown) accommodated between the shell 32′ and the holder 35′, and at least one power supply terminal (forming a power supply interface) electrically connected to the battery cell. Referring to FIG. 17 and FIG. 18, the battery pack 30′ is configured to be removably assembled with the power tool, so that an electrical connection between a tool interface of the power tool and a power supply interface of the battery pack 30′ is formed or eliminated. The connecting component 40′ is configured to be removably assembled with a base 22′ of the household appliance 20′, so that an electrical connection between an appliance interface of the household appliance 20′ and the power supply interface of the battery pack 30′ is formed or eliminated. The plurality of power tools can include electric drill, electric hammer, angle grinder, sander, curve saw, reciprocating saw, electric circular saw, chain saw, pruner and so on, in this embodiment, the power tool is an electric drill. The plurality of household appliances can include juicer, flour mixer, meat grinder, multifunctional food processor, vacuum cleaner and so on, in this embodiment, the household appliance is a multifunctional food processor.

The connecting component 40′ includes a first bracket 411′, a second bracket 412′, a first locking portion 423′, and a first driving portion 424′. The first bracket 411′ and the second bracket 412′ are assembled with each other to clamp the holder 35′. The first locking portion 423′ protrudes from the first bracket 411′ and the second bracket 412′. The first locking portion 423′ is cooperated with the base 22′ of the household appliance 20′, so that the first locking portion 423′ is locked with the base 22′ of the household appliance 20′. The first driving portion 424′ is operated by user to drive the first locking portion 423′, so that the first locking portion 423′ can be unlocked from the base 22′ of the household appliance 20′. In fact, a movement of the first locking portion 423′ and a movement of the first driving portion 424′ are synchronous. The power assembly 10′ is inserted into the docking cavity 23′ of the base 22′, so that the first locking portion 423′ is cooperated with the base 22′. The first driving portion 424′ has a driving direction, the driving direction of the first driving portion 424′ revolves around a straight line parallel to an insertion direction of the power assembly 10′, that is, the first driving portion 424′ is operated by rotating.

The first bracket 411′ has a first surface 410′ facing the first driving portion 424′. The first driving portion 424′ and the first locking portion 423′ are fixedly connected with each other, the first driving portion 424′ and the first locking portion 423′ are located on two opposite sides of the first surface 410′. The first locking portion 423′ protrudes from the first bracket 411′ and the second bracket 412′. The shell of the base 22′ also has a position limiting slot 24′ communicating with the docking cavity 23′ and a notch 25′ that interrupts the position limiting slot 24′ on the circumference. The position limiting slot 24′ prevents the first locking portion 423′ from being removed from the base 22′, and the notch 25′ allows the first locking portion 423′ to be removed from the base 22′. That is, when the first driving portion 424′ is rotated, the first locking portion 423′ aligns with the notch 25′, thus the power assembly 10′ can be removed. When the first locking portion 423′ is locked in the position limiting slot 24′, the power assembly 10′ cannot be removed. The first surface 410′ is used as a guiding surface for the rotational movement of the first driving portion 424′.

A closed through slot 200′ is formed by the first bracket 411′ and the second bracket 412′. The first locking portion 423′ is slidably mounted in the through slot 200′, so that the through slot 200′ provides a guidance for the first locking portion 423′.

The first driving portion 424′ includes an arch-shaped hand-holding portion 420′. When the power assembly 10′ is assembled with the base 22′, at least part of the hand-holding portion 420′ protrudes from the base 22′, facilitating an operation of user. The connecting component 40′ also includes a bridging portion 425′ connecting the first locking portion 423′ and the first driving portion 424′. The bridging portion 425′ covers the battery pack 30′ and is concaved in a direction towards the battery pack 30′, thereby forming a roughly spherical space between the bridging portion 425′ and the hand-holding portion 420′, facilitating an insertion of the user's hand to operate the first driving portion 424′. Additionally, user can lift the power assembly 10′ by the hand-holding portion 420′ after the first driving portion 424′ is operated by rotating and the first locking portion 423′ is unlocked from the base 22′, the operating process is smooth and comfortable.

The household appliance 20′ includes a base 22′, a motor (not shown) received in the base 22′, and an output shaft (not shown) driven by the motor. The power assembly 10′ is inserted into the docking cavity 23′ of the base 22′. The axis of the motor and the axis of the output shaft are perpendicular to the insertion direction of the power assembly 10′. When the household appliance 20′ is in an upright position, the power assembly 10′ is located below the motor. Due to a large weight of the battery cell, this design ensures that the center of gravity of the household appliance 20′ is lower, making it less prone to tipping over and enhancing safety during use. The shell of the base 22′ is provided with at least one heat dissipation hole (not shown) that communicates the docking cavity 23′ with an outer space. Specifically, the at least one heat dissipation hole can be set at the bottom of the shell of the base 22′. This design is beneficial for improving the heat dissipation effect of the power assembly 10′.

The battery pack 30, 30′ of the power assembly 10, 10′ of the present application can adapt to a plurality of power tools. The power assembly 10, 10′ as a whole can adapt to a plurality of household appliances 20, 20′, further enhancing universality and helping to reduce cost.

The aforementioned descriptions are merely preferred embodiments of this application and are not intended to limit the scope of the invention. Any modification or replacement made by those skilled in the art based on the spirit and principle of this invention should be comprised within the scope of the patent claims of this application.

I claim:

1. A power assembly for a power tool and a household appliance, the power tool comprising a tool body and a tool interface formed on the tool body, the household appliance comprising a base and an appliance interface formed on the base, the power assembly comprising:
a battery pack, comprising a shell and at least one battery cell arranged in the shell, the battery pack comprising a power supply interface electrically connected with the at least one battery cell;
a connecting component, removably connected to the battery pack, the connecting component comprising a first locking portion for locking with the base and a first driving portion for driving the first locking portion to unlock from the base;
wherein the battery pack is configured to be removably assembled with the tool body, so that an electrical connection between the tool interface and the power supply interface is formed or eliminated; and
the connecting component is configured to be removably assembled with the base, so that an electrical connection between the appliance interface and the power supply interface is formed or eliminated.

2. The power assembly according to claim 1, wherein the connecting component comprises a bracket and at least one locking member mounted on the bracket, the locking member comprises the first locking portion and the first driving portion, the first driving portion drives the first locking portion to move, and the connecting component further comprises a first elastic member, the first elastic member is configured to provide a restoring force for the first locking portion.

3. The power assembly according to claim 2, wherein the at least one locking member comprises two locking members corresponding to each other, the first elastic member is located between the two locking members, one end of the first elastic member cooperates with the first driving portion of one of the two locking members, and the other end of the first elastic member cooperates with the first driving portion of the other one of the two locking members.

4. The power assembly according to claim 2, wherein the battery pack extends in a first direction, the at least one locking member comprises two locking members, the first driving portion of one of the two locking members and the first driving portion of the other one of the two locking members are corresponding to each other and arranged in a second direction perpendicular to the first direction, and a first driving direction of the first driving portion of the one of the two locking members is opposite to a second driving direction of the first driving portion of the other one of the two locking members, and the first driving direction and the second driving direction are parallel to the second direction.

5. The power assembly according to claim 2, wherein the first driving portion comprises a first positioning element, the at least one locking member comprises two locking members, and two ends of the first elastic member are respectively positioned at the first positioning element of the first driving portion of one of the two locking members and the first positioning element of the first driving portion of the other one of the two locking members.

6. The power assembly according to claim 4, wherein the bracket comprises a first bracket and a second bracket that assembled with each other; two first through slots are formed after the first bracket and the second bracket are assembled with each other, the first through slot penetrates in the second direction; the two first through slots are corresponding to each other and arranged in the second direction, the two locking members are mounted on the first bracket, the first locking portion of one of the two locking members and the first locking portion of the other one of the two locking members pass through the two first through slots respectively and are exposed to the bracket.

7. The power assembly according to claim 6, wherein the second bracket comprises a main body and a movable member movably connected to the main body, the main body has a mounting cavity with a mounting opening, the battery pack is inserted into the mounting cavity from the mounting opening, the movable member comprises a second locking portion and a second driving portion for driving the second locking portion to move, the second locking portion locks with the battery pack to fix the battery pack to the connecting component, and the second bracket also comprises a second elastic member positioned between the second driving portion and the main body, and the second elastic member is configured to provide a restoring force for the second locking portion.

8. The power assembly according to claim 7, wherein the movable member comprises a positioning pin, the main body has a positioning hole, the positioning pin is inserted into the positioning hole, and the movable member rotates relative to the main body to make the second locking portion lock or unlock with the battery pack.

9. The power assembly according to claim 7, wherein the second driving portion comprises a second positioning element, the main body comprises a third positioning element, one end of the second elastic member is positioned at the second positioning element of the second driving portion, and the other end of the second elastic member is positioned at the third positioning element of the main body.

10. The power assembly according to claim 7, wherein the main body comprises a second through slot communicating with the mounting cavity, the battery pack comprises a holder located in the mounting cavity, and the second locking portion enters the mounting cavity from the second through slot to lock with the holder.

11. The power assembly according to claim 1, wherein the power assembly is assembled with the base of the household appliance along an insertion direction, the first driving portion has a driving direction, the driving direction of the first driving portion revolves around a straight line parallel to the insertion direction of the power assembly.

12. The power assembly according to claim 1, wherein the connecting component comprises a first bracket and a second bracket, the first bracket and the second bracket are assembled with each other to clamp the battery pack.

13. The power assembly according to claim 12, wherein the first bracket comprises a first surface facing the first driving portion, the first driving portion and the first locking portion are fixedly connected with each other, the first driving portion and the first locking portion are located on two opposite sides of the first surface, the first locking portion protrudes from the first bracket and the second bracket.

14. The power assembly according to claim 13, wherein the first driving portion comprises an arch-shaped hand-holding portion, when the power assembly is assembled with the base of the household appliance, at least part of the hand-holding portion protrudes from the base, the connecting component also comprises a bridging portion connecting the first locking portion and the first driving portion, the bridging portion covers the battery pack and is concaved in a direction towards the battery pack, a space between the bridging portion and the hand-holding portion is formed.

15. A household appliance comprising:
the power assembly according to claim 1;
a base, comprising a docking cavity;
an appliance interface, formed on the base and disposed in the docking cavity, the appliance interface being electrically connected with the power supply interface of the power assembly in the docking cavity;
a motor, received in the base and electrically connected with the appliance interface;
an output shaft, driven by the motor;
wherein the power assembly is configured to be removably assembled with the base, so that an electrical connection between the appliance interface and the power supply interface is formed or eliminated;
the base also comprises a position limiting slot communicating with the docking cavity, and the first locking portion cooperates with the position limiting slot to lock the first locking portion with the base;
the battery pack of the power assembly is a battery pack for a power tool, the power tool comprises a tool body and a tool interface formed on the tool body, and the battery pack can be removably assembled with the tool body, so that an electrical connection between the tool interface and the power supply interface is formed or eliminated.

16. The household appliance according to claim 15, wherein the base further comprises a notch that interrupts the position limiting slot on the circumference, the position limiting slot prevents the first locking portion from being removed from the base, and the notch allows the first locking portion to be removed from the base.

17. The household appliance according to claim 15, wherein when the household appliance is in an upright position, the power assembly is located below the motor.

18. The household appliance according to claim 15, wherein the power assembly is inserted into the docking cavity of the base, an axis of the motor and an axis of the output shaft are perpendicular to an insertion direction of the power assembly.
